(19) United States
(12) Patent Application Publication
(10) Pub. No.: US 2019/0391706 A1
(43) Pub. Date: Dec. 26, 2019

(54) COMPUTING DEVICE WITH DYNAMIC TIME FLUX REGULATOR AND LOCK-IN USER INTERFACE ELEMENTS

(71) Applicant: Biddl Oy, Helsinki (FI)

(72) Inventors: Lasse Diercks, Helsinki (FI); Joakim Carl Michael Nordling, Esbo (FI); Markus Antero Haverinen, Helsinki (FI); Dao Anh Tuan, Espoo (FI)

(21) Appl. No.: 16/015,473

(22) Filed: Jun. 22, 2018

(51) Int. Cl. G06F 3/0482; G06F 17/30; G06Q 30/06; G04F 1/00; G04F 10/00

(52) U.S. Cl. CPC G06F 3/0482; G06F 17/30321; G04F 10/00; G04F 1/005; G06Q 30/0641

(57) ABSTRACT

A computing device with dynamic time flux regulator and lock-in user interface elements may include a time clock interface element where index data associated with an item is selectable within a first duration of time displayed on the time clock interface element. The lock-in user interface element, when executed, selects as reserved the index data associated with the item. In response to receiving a first activation input within the first duration, the user interface displays a modified lock element of the user interface transformed from an unlocked state to a locked state that indicates the index data associated with the product is reserved. Additionally, and in response to receiving the first activation input within the first duration, one or both of the user interface and an associated client device, may output a sensory response indicative of the locked state.

### FIELD

The application relates generally to a computing device with dynamic time flux regulator and lock-in user interface elements.

### BACKGROUND

Mechanics of index data interfaces and back-end server operations can involve some degree of output fluctuation in index data at various intervals of time. Typically, the index data may be available, valid, or accurate only during a particular interval of time, without prospective effect once the interval of time has lapsed. However, the time intervals at which such fluctuation to the index data can occur may be unknown to an end user. Additionally, the degree of fluctuation to the index data may apply to all end users.

The subject matter claimed herein is not limited to embodiments that solve any disadvantages or that operate only in environments such as those described above. Rather, this background is only provided to illustrate one example technology area where some embodiments described herein may be practiced.

### SUMMARY

Embodiments of the disclosure discuss various operations performed in a method, system, and/or computer-readable medium. The operations may include receiving, via a user interface of a client device, a selection of a product. Additionally, the operations may include identifying index data associated with the product. The operations may also include displaying, via the user interface, a time clock interface element where the index data associated with the product may be selectable within a first duration of time that is displayed on the time clock interface element. Additionally, the operations may include displaying, via the user interface, the index data associated with the product and a first user interface element that, when executed, selects as reserved the index data associated with the product. The operations may further include receiving, via the user interface, a first activation input to activate the first user interface element to select as reserved and the index data associated with the product. Additionally, the operations may include determining that the first activation input is received within the first duration of time displayed on the time clock interface element. In response to receiving the first activation input within the first duration, the operations may also include modifying a lock element of the user interface from an unlocked state to a locked state that indicates the index data associated with the product is reserved. Additionally, the operations may include outputting, via one or both of the user interface and the client device, a sensory response indicative of the locked state.

### BRIEF DESCRIPTION OF THE DRAWINGS

Example embodiments will be described and explained with additional specificity and detail through the use of the accompanying drawings in which:

FIG. 1 illustrates an example environment;

FIG. 2 illustrates an example schematic depicting an example flow of index data relative to the index data manager and the client device of FIG. 1;

FIG. 3 illustrates another example schematic depicting an example flow of index data relative to the index data manager and the client device of FIG. 1;

FIGS. 4A-4F illustrate an example user interface of the client device of FIG. 1;

FIG. 5 illustrates an example curve fit schematic generated by the curve fit manager of FIG. 1;

FIGS. 6A-6C illustrate an example method to facilitate locking-in and finalizing index data that may be implemented in the environment of FIG. 1;

FIGS. 7A-7C illustrate another example method to facilitate locking-in and finalizing index data that may be implemented in the environment of FIG. 1; and

FIG. 8 illustrates a block diagram of an example computing system.

### DESCRIPTION OF EMBODIMENTS

Many client devices today include user interfaces where a user may scroll, swipe, slide, tap, press, etc. to provide a user input to the client device. More particularly, conventional user interfaces may include a screen allowing the user to view index data for a particular item. For example, in some applications, the user interface may include viewable index data for a particular item and perhaps different index data for similar (but different) items (e.g., different flights to and from a given destination as may be found on an Expedia® flight list or similar books viewed by others). In other applications, the user interface may include multiple sets of index data for a particular item where each individual index data corresponds to a unique source (e.g., one product listed by multiple sources such as may be found on an Amazon® product listing).

In these and/or in other conventional user interfaces, the user may be forced or required to filter, scroll, sort, adjust default settings, leave a website, visit alternative sources/links, etc. (via some user input) in order for the user to view multiple potential options and arrive at a desired item with correspondingly desired index data. Additionally or alternatively, conventional user interfaces may require filtering, scrolling, sorting, adjusting default settings, leaving a web site, visiting alternative sources/links, etc. (via some user input) in order for the user to arrive at an acceptable or preferred index data/index data threshold (e.g., filter list by discount from high to low). Any of the above-mentioned actions, and other similar actions, may result in a myriad of user inefficiencies, far too many inputs received at the client device, and time consuming preliminary steps and client device operations.

Aspects of the present disclosure address these and other problems with conventional systems by providing a new user interface with a dynamic time flux regulator and lock-in elements. In some aspects, the dynamic time flux regulator in the new user interface may allow a user to view changing index data for a particular item (or multiple items) without additional steps and inputs such as filtering, scrolling, sorting, adjusting default settings, leaving a website, visiting alternative sources/links, etc. Additionally or alternatively, in some aspects, the locking feature in the new user interface may allow a user to reserve or lock-in (via a user input) a particular set of index data corresponding to a particular item. After activating the locking feature (in combination with the dynamic time flux regulator), the user may view different (e.g., alternative) index data for the same item without additional steps and inputs such as filtering, scrolling, sorting, adjusting default settings, leaving a web site, visiting alternative sources/links, etc.

Additionally or alternatively, aspects of the present disclosure address the above-mentioned problems rooted in technology, among others, with conventional user interfaces by providing a new user interface with dynamic time flux regulator and lock-in elements using visual cues in the new user interface, such as a color coding system, an icon/symbol system, a shape system, or other cue system (including systems that implement non-visual cues) that represents a quality/type of the index data (e.g., a discount amount). For instance, adding color to the new user interface in conjunction with the dynamic time flux regulator and lock-in elements may help allow the user to view multiple items on a page (each item having changing index data) in addition to visually aiding the user to spot a specific item that is associated with a particular color representing a certain type of index data (e.g., a rare find) and lock-in via a user input that specific item. In this manner, the user can visually watch, without unnecessary steps and inputs, for a particular color (and/or icon, symbol, shape, etc.) and, then once spotted, lock-in the item/index data associated with the particular color (and/or icon, symbol, shape, etc.).

In these or other embodiments of the new and improved user interface, the dynamic time flux regulator, the lock-in element, and/or the cueing system, as particularly arranged individually or in combination, may help to reduce a number of user steps/inputs thereby adding simplicity to the user interface and/or may increase user efficiency.

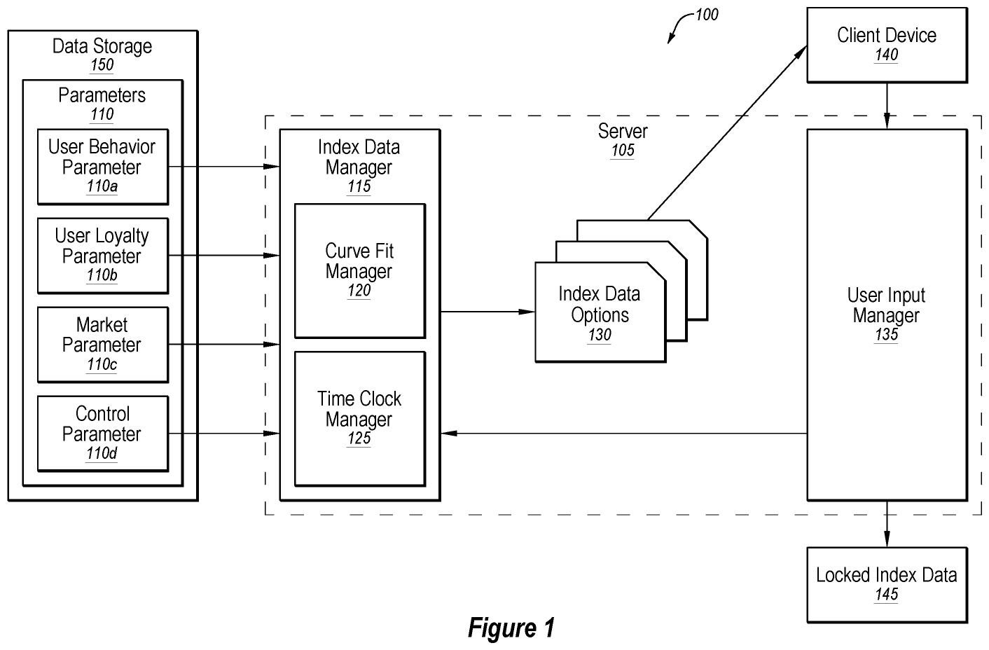

Turning to the figures, FIG. 1 illustrates an example environment 100. The environment 100 may be arranged in accordance with at least one embodiment described in the present disclosure. As illustrated, the environment 100 may include a server 105, a client device 140, and data storage 150. In some embodiments, the server 105 may include one or more computing devices, such as a rackmount server, a router computer, a server computer, a personal computer, a mainframe computer, a laptop computer, a tablet computer, a desktop computer, a smartphone, cars, drones, a robot, any mobility device that has an operating system, etc.), data stores (e.g., hard disks, memories, databases), networks, software components, and/or hardware components.

The server 105 may be configured to receive parameters 110, including for example, a user behavior parameter 110a, a user loyalty parameter 110b, market parameters 110c, and control parameters 110d. For example, in some embodiments, the server 105 may receive the parameters 100 in response to the client device 140 sending the parameters 110 to the server 105. Additionally or alternatively, a third-party client device may send the parameters 110 to the server 105. Additionally or alternatively, one portion of the server 105 may send the parameters 110 to another portion of the server 105 (e.g., an intra-server communication such as between an index data manager 115 and a user input manager 135). In these or other embodiments, the parameters 110 may be received at the server 105 via any manner of data transmission, computer-readable medium, or computer executable instructions. The server 105 may also receive user input from the client device 140 via the user input manager 135. In some embodiments, the server 105 may send data (e.g., to the client device 140) related to index data, including for example, the index data options 130.

In these or other embodiments, the client device 140 may include a processor-based computing system. For example, the client device 140 may include memory, a processor, and network communication capabilities. In the environment 100, the client device 140 may be capable of communicating and receiving data and information to and from the server 105 via the network. Some examples of the client device 140 may include a mobile phone, a smartphone, a tablet computer, a laptop computer, a desktop computer, a set-top box, a virtual-reality device, a wearable device, or a connected device, etc.

In these or other embodiments, the server 105 and the client device 140 may be communicatively coupled via a network connection over a network such that data may be transmitted from or received at any of the server 105 and the client device 140. The network may include a public network (e.g., the Internet), a private network (e.g., a local area network (LAN) or wide area network (WAN)), a wired network (e.g., Ethernet network), a wireless network (e.g., an 802.xx network, a Wi-Fi network, or a Bluetooth® network), a cellular network (e.g., a Long Term Evolution (LTE) or LTE-Advanced network, 1G, 2G, 3G, 4G, 5G, etc.), routers, hubs, switches, server computers, and/or a combination thereof.

In these or other embodiments, the environment 100 may include the data storage 150. The data storage 150 may be local to the server 105 or within the network as cloud storage. In some embodiments, the data storage may include computer-readable storage media or one or more computer-readable storage mediums for carrying or having computer-executable instructions or data structures stored thereon. Such computer-readable storage media may be any available media that may be accessed by a processor, such as a processor from the server 105 and/or the client device 140. Additionally or alternatively, the data storage 150 may be communicatively coupled to one or both of the server 105 and the client device 140 via the network.

In these or other embodiments, the parameters 110 may be data stored within the data storage 150 and may include various parameters such as the user behavior parameter 110a, the user loyalty parameter 110b, the market parameters 110c, and the control parameters 110d described below.

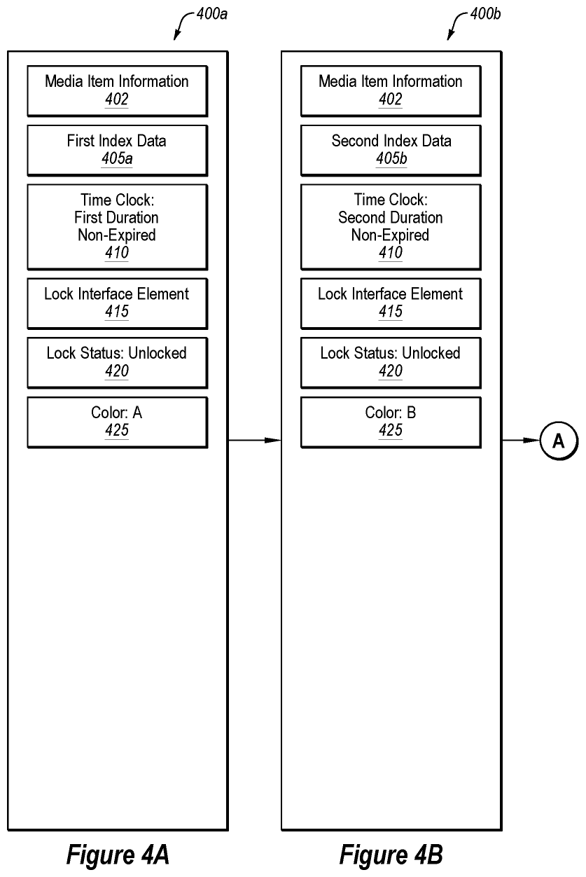

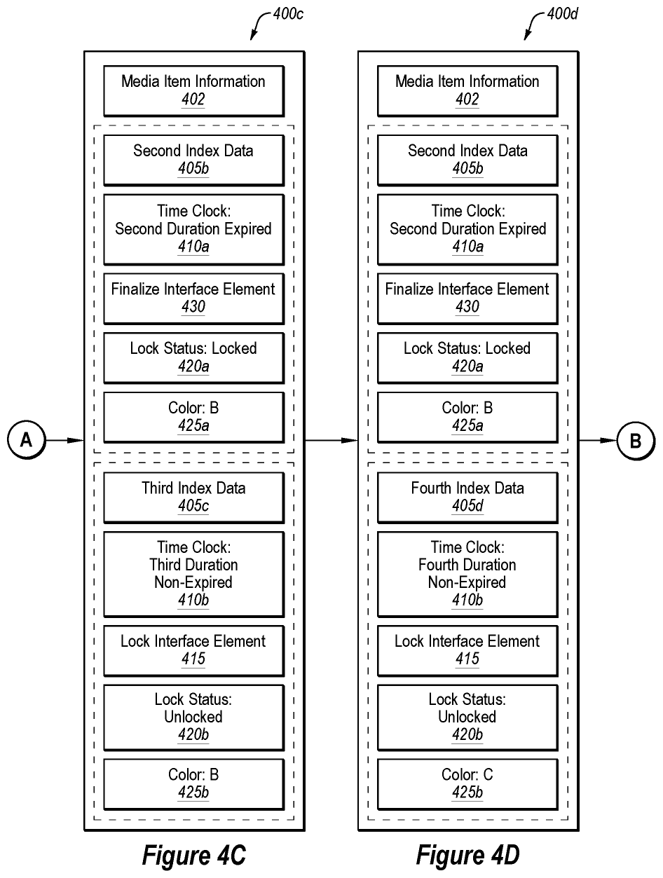

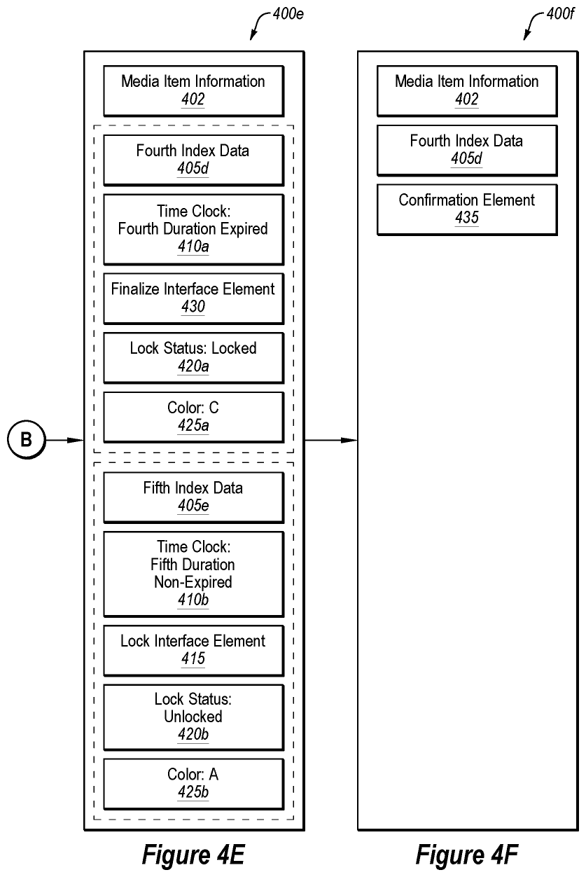

The user behavior parameter 110a may include behavior of the user such as an amount of idle time. Idle time may include an amount of time that a user has not engaged with a user interface of the client device 140. For example, the user may be “viewing” only without interfacing with a lock interface element (discussed further below in conjunction with FIGS. 4A-4F) of the user interface. Additionally or alternatively, the user behavior parameter 110a may include any amount of interfacing, by the user, with the lock interface element of the user interface. For example, the user may interface with the lock interface element only once, twice, or some other quantity of interaction. Additionally or alternatively, the user behavior parameter 110a may include behavior of the user where the user interfaces with the lock interface element to lock in the index data at a high value (e.g., at a high price) or a low value (e.g., at a low price).

The user loyalty parameter 110b may describe how loyal a user is and/or various aspects of user loyalty. In some embodiments, the user loyalty parameter 110b may include a portion of the user behavior parameter 110a, such as an indicator (numerical or other suitable indicator) of how often the user merely visits the user interface versus participating with the user interface. Additionally or alternatively, the user loyalty parameter 110b may include an indicator (numerical or other suitable indicator) of how often the user participates in games associated with the user interface. For example, games may include daily puzzles, missions, opening mystery packages, etc. to gain points, levels, status, power, coins, etc. Thus, in some embodiments, the user loyalty parameter 110b may include an indicator of one or more of points, levels, status, power, coins, etc. Additionally or alternatively, the user loyalty parameter 110b may include an indicator (numerical or other suitable indicator) of how many referrals the user extends to friends/other potential users. For example, a referral may include a message or some other invitation for a potential user to join.

In some embodiments, the market parameters 110c may include a retail price, e.g., a manufacturer suggested retail price (MSRP) or an actual retail price of one or more sellers. Additionally or alternatively, the market parameters 110c may include a minimum price such as a wholesale price, a “break-even” price (e.g., at cost price), or some other price threshold such as any price between the MSRP and the minimum price.

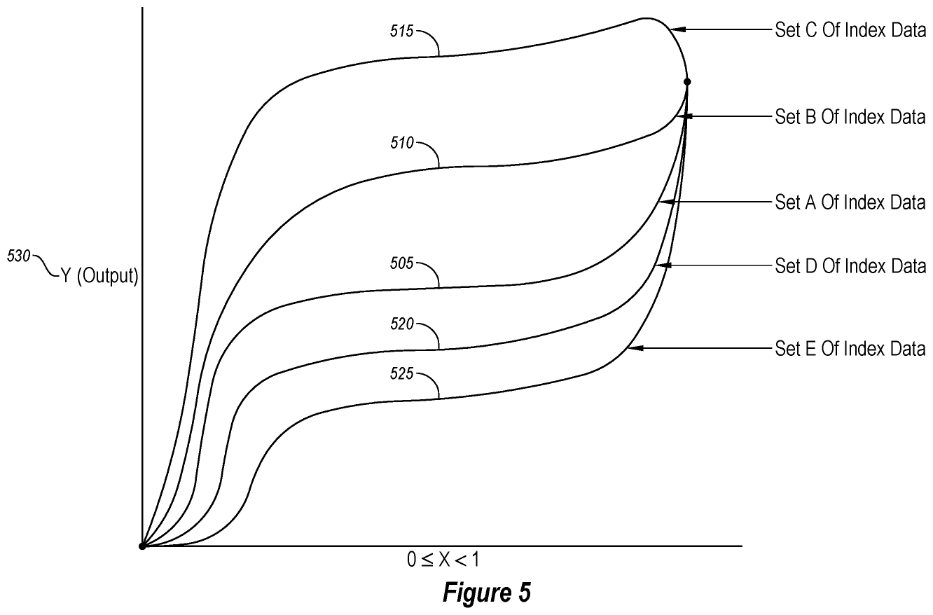

In some embodiments, the control parameters 110d may include curve fit parameters as discussed in further detail below and also in conjunction with FIG. 5. The curve fit parameters may help control a distribution of index data. As referred to herein, index data may include a price, an amount of loyalty points, a discount amount, and/or some other value configured to be associated with an item such as a product for sale. Additionally or alternatively, index data may include any computer executable instructions and/or any memory-storable data associated with or related to the item such as time-based data.

In some embodiments, the index data manager 115 performs curve generation, data generation (e.g., generation of the index data options 130), data transmission, and data receiving. The index data manager 115, though illustrated in FIG. 1 as within the server 105, may reside within the client device 140. Additionally or alternatively, the index data manager 115 may reside within both of the server 105 and the client device 140, for example, a first index data manager 115 within the server 105 and a second index data manager 115 within the client device 140. In these or other embodiments, the index data manager 115 may include a curve fit manager 120 and a time clock manager 125. For example, the index data manager 115 may facilitate communication between the time clock manager 125 and the curve fit manager 120. Additionally or alternatively, the index data manager 115 may facilitate communication between one or both of the curve fit manager 120 and the time clock manager 125 and another portion of the server 105 (e.g., the user input manager 135). Additionally or alternatively, the index data manager 115 may facilitate communication between one or both of the curve fit manager 120 and the time clock manager 125 and the client device 140. Both of the curve fit manager 120 and the time clock manager 125 are described below.

The curve fit manager 120 may, in response to receiving the parameters 110 at the index data manager 115, generate a curve, change a curve, etc. The curve(s) may be associated with the index data as viewed by the user in the user interface (the curve being described in additional detail in conjunction with FIG. 5). For example, in response to determining some threshold amount of idle time as determined by accessing the user behavior parameter 110a, the curve fit manager 120 may adjust the curve so as to increase a possibility that better index data (e.g., a larger discount in price) is included in the index data options 130 and subsequently displayed to the user via the user interface at the client device 140.

In another example, in response to determining that the user has engaged in minimal locking as determined by accessing the user behavior parameter 110a, the curve fit manager 120 may adjust the curve up or down so as to increase or decrease the possibility of higher or lower index data being included in the index data options 130 and subsequently displayed to the user via the user interface at the client device 140. In another example, in response to determining that the user has engaged in a high value lock as determined by accessing the user behavior parameter 110a, the curve fit manager 120 may adjust the curve to shift down so as to increase a possibility that better index data (e.g., a larger discount in price) is included in the index data options 130 and subsequently displayed to the user via the user interface at the client device 140.

In another example, other parameters or variables may be considered by the curve fit manager 120. For example, the curve fit manager 120 may adjust the curve associated with the index data in response to determining a total number of online participants are viewing an item and/or a total number of online participants have locked-in a given set of index data for an item. For instance, the curve fit manager 120 may determine that a total number of online participants viewing an item is over or under a particular threshold, and in response, the curve fit manager 120 may shift the curve of the index data up or down. Similarly, responsive to determining that a total number of online participants have locked-in a given set of index data for an item where the number is over or under a particular threshold, the curve fit manager 120 may shift the curve of the index data up or down.

In another example, the curve fit manager 120 may determine a specific curve for a particular product. For example, the curve fit manager 120 may generate a curve for a popular item that is shifted higher than curves associated with less popular items. Additionally or alternatively, the user behavior parameter 110a may indicate that the user has a particular interest in a certain item and may thus generate or adjust a curve accordingly. As another example, the curve fit manager 120 may generate or adjust a curve based on a category of an item (e.g., outdoor sporting goods, kitchenware, bedding, electronics, etc.). Additionally or alternatively, the user behavior parameter 110a may indicate that the user has a particular interest in a certain category of items and may thus generate or adjust a curve accordingly.

In another example, the curve fit manager 120 may adjust or generate a curve based on a conversion rate of the user. A conversion rate of the user may include a ratio of locking in index data for items versus finalizing the items at the locked-in index data (e.g., locks versus purchases). For example, the curve fit manager 120 may adjust or generate a curve differently for users with a lower conversion rate (e.g., a higher number of locks compared to a lower number of purchases) than for users with a higher conversion rate (e.g., the number of locks may not be substantially higher than the number of purchases).

In another example, the curve fit manager 120 may adjust or generate a curve for an item based on the user loyalty parameter 110b. For example, the curve fit manager 120 may adjust or generate a curve differently for a user with a higher amount of user loyalty as described in the user loyalty parameter 110b than for a user with a lower amount of user loyalty as described in the user loyalty parameter 110b. Additionally or alternatively, the user input manager 135 may send a data request from the client device 140 that an amount of user loyalty (e.g., a number of points, coins, tokens, etc.) as described in the user loyalty parameter 110b be applied to the index data options 130. For example, the curve fit manager 120 may, in response to a user input relayed to the index data manager 115, adjust or generate a curve for an item based on user loyalty. Thus, in some embodiments, the user loyalty parameter 110b may affect a buying power of the user. For example, based on the user loyalty parameter 110b, a user may have more or less opportunity to more desirable index data.

In another example, the curve fit manager 120 may adjust or generate a curve for an item/user based on the market parameters 110c and/or the control parameters 110d. For example, the market parameters 110c and the control parameters 110d may include curve fit parameters that may help determine the layout of the curve, such as a slope, a shift, a curvature, etc. of the curve. Additionally or alternatively, the market parameters 110c and the control parameters 110d may help control a distribution of index data such that more or less index data is distributed at higher or lower values (e.g., at higher or lower prices). Additional details regarding the market parameters 110c and the control parameters 110d are discussed in further detail below in conjunction with FIG. 5.

In these or other embodiments, the curve fit manager 120 may adjust or generate one or more curves to increase revenue, incentivize more users to lock-in index data, increase user engagement with the index data, and/or increase a probability of conversion.

In some embodiments, the time clock manager 125 may include a processor-based element capable of tracking time, time-stamping user inputs received from the client device 140 via the user input manager 135, sending time-based data associated with the index data options 130 to the client device 140, refreshing a time clock interface on the user interface of the client device 140, verifying the time-stamped user inputs with the time-based data associated with the index data options 130, managing tolerance periods of time during which a user input may be acceptable, etc. In these or other embodiments, the time clock manager 125 may manage any data transmission to or from the server 105 having time-based elements or are related to time-based elements. For example, the time clock manager 125 may send a data packet to the client device 140 to be executed. Once executed at the client device 140, a time clock interface element of the user interface at the client device 140 may count up X amount of time or count down to zero from X amount of time (e.g., the time clock interface element may be a visual graph element showing the change in time as tracked and/or instructed by the time clock manager 125. Additionally or alternatively, the time clock manager 125 may assign a predetermined lifetime for any given index data. In some embodiments, the predetermined lifetime may be constant between all index data, but in other embodiments different between one or more index data. The predetermined lifetime of the index data may correspond to a displayed duration of time on the time clock interface element on the user interface.

In some embodiments, one or more of the index data manager 115, the curve fit manager 120, and the time clock manager 125 may output the index data options 130. For example, the index data options 130 may be output to the client device 140 all at once, in groupings of index data (e.g., groups of 2, 3, 5, 10, 50, 100, etc. for one or more items), or in individual index data packets (e.g., data corresponding to a single index data for one or more items). The index data options 130 may include a set of prices, a set of loyalty points, and/or some other set of values or figures configured to be associated with one or more items such as a product for sale. Additionally or alternatively, index data options 130 may include any computer executable instructions and/or any memory-storable data associated with or related to the item such as time-based data. Additionally or alternatively to sending the index data options 130 to the client device 140, the server 105 may cause the index data options 130 to be stored in the data storage 150. Additionally or alternatively, the client device 140 may store the index data options 130.

In these or other embodiments, the locked index data 145 may be a particular subset of the index data options 130 that has been selected by the user. The server 105 may cause the locked index data 145 to be stored in the data storage 150. Additionally or alternatively, the client device 140 may store the locked index data 145. In these or other embodiments, the locked index data 145 may be relayed from the client device 140 via the user input manager 135 discussed below.

In some embodiments, the user input manager 135 may include a processor-based element capable of communicating information to the index data manager 115 received at the client device 140. Though the user input manager 135 is illustrated in FIG. 1 as residing within the server 105, such an implementation is one example embodiment. In other embodiments, the user input manager 135 may reside within the client device 140. Additionally or alternatively, the user input manager 135 may reside within both of the server 105 and the client device 140, for example, a first user input manager 135 within the server 105 and a second user input manager 135 within the client device 140. In these or other embodiments, the user input manager 135 may be configured to receive information from the user input via the client device 140. For instance, the client device 140 may transform a user input in the form of an executed button on the user interface of the client device 140, a text message, an email message, a shake of the client device 140, a voice command from the user, etc. to a data signal that is communicated to the user input manager 135. Additionally or alternatively, based on user input from the client device 140, the user input manager 135 may output the locked index data 145 to the index data manager 115, the client device 140 (e.g., to the user interface), and/or a component of the server 105. Additionally or alternatively, based on an additional user input from the client device 140, the user input manager 135 may output a finalized index data where the locked index data 145 is selected again (e.g., to purchase an item at the selected price).

The following are some additional example problems of conventional index data systems where index data may indicate a real-time valuation or value of a product. In some index data systems, the index data may fluctuate at seemingly random intervals that are often unknown to a user. The randomness of index data interval flux may be driven by product manufacturers, market conditions, investors, and/or a wide variety of other variables. Additionally, in some index data systems, the index data may have a discrete, non-extendable lifetime such that the index data may be available, valid, or accurate only during a particular interval of time, without prospective effect once the interval of time has lapsed. For example, in some index data systems, after the time interval has lapsed for a given set of index data, the index data may no longer be available to any user. Thus, in other index data systems, users may be presented with new available index data replacing the expired index data (at unknown times) that may be the same for all users (e.g., user independent).

Additional benefits of present disclosure may include a user interface and/or a server with index data locking capability. For example, locked index data may include index data reserved to a user, enabling viability of the index data even beyond expiration of the index data. In these or other embodiments, without locking the index data before expiration of the index data, the index data may expire such that the index data is no longer available. Upon expiration of the index data, a different index data may be generated and/or displayed to the user (e.g., for selecting to lock-in the index data or waiting for its expiration and subsequent replacement index data). In these or other embodiments, the index data and each subsequent index data may correspond to a predetermined curve. The curve may be generated using various parameters. Given various parameters, index data may be individualized such that any one curve for a user may be shifted, the index data may correspond to a particular portion of the curve, or a new curve may be generated. Thus, in some embodiments, multiple users may simultaneously view a product, but each of the multiple users may view different index data associated with the product at any one time.

In an example scenario where a given index data has been locked-in in response to a user input, some embodiments described in this disclosure may include a user interface and/or a server 105 that generates or displays real-time index data alternatives to the locked index data 145. In these or other embodiments, index data that is unlocked or unreserved is available for a predetermined period of time that is known to the user (e.g., via a clock interface element that displays a duration of available time to lock-in the index data). Thus, in some embodiments, the user may choose to select, after an initial selection locking in a first index data, a second index data that is different from the first index data. In this manner, the user interface may transform at predetermined intervals (e.g., every 5 seconds, 10 seconds, 30 seconds, 60 seconds, 180 seconds, etc.) to include different index data available for selecting. Each different index data may be more advantageous or less advantageous for the user, relative to previous index data. Additionally or alternatively, in some embodiments, in response to a user selecting index data, a client device 140 and/or the user interface of the client device 140 may output a sensory response, including one or more of a visual response, an auditory response, a tactile response, etc.

In these or other embodiments, the system and methods described herein may improve product conversion rates and user interfaces in a novel manner. Where conventional systems and methods aim to get users to “check out” fast to increase product conversion rates, the systems and methods described herein may employ a particular combination of index data locking capabilities and index data fluctuation at predetermined intervals (which allows the rewarding of user strategy and user patience) to increase product conversion rates and user efficiency with a user interface. Antithetical to the “check out fast” approach, the methods disclosed herein improve user engagement using the combination of index data locking capabilities and index data fluctuation at predetermined intervals, which may, for example, increase a viewership/participation duration per user (e.g., lengthen user engagement), increase user loyalty and probability of return, increase user ability to receive more product at individualistic rates, remove extra steps (e.g., scrolling, filtering, etc.) and/or remove a motivation/need to visit other sites, etc.

Modifications, additions, or omissions may be made to the environment 100 without departing from the scope of the present disclosure. For example, in some embodiments, the environment 100 may include any number of other components that may not be explicitly illustrated or described. The present disclosure more generally applies to the environment 100 including the client device 140, index data options 130, locked index data 145, parameters 110, and the server 105, or any combination thereof. The server 105 may include: the index data manager 115 having the curve fit manager 120 and the time clock manager 125, and the user input manager 135.

Moreover, the separation of various components in the embodiments described herein is not meant to indicate that the separation occurs in all embodiments. In addition, it may be understood with the benefit of this disclosure that the described components may be integrated together in a single component or separated into multiple components.

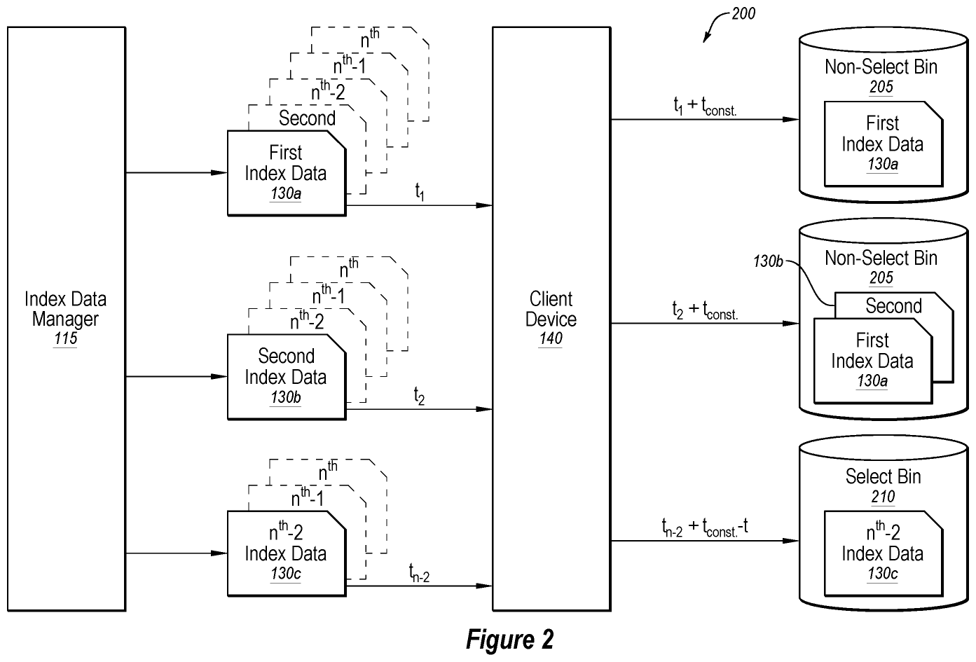

FIG. 2 illustrates an example schematic 200 depicting an example flow of index data relative to the index data manager 115 and the client device 140, arranged in accordance with at least one embodiment described in the present disclosure. As illustrated, the schematic 200 may include the index data manager 115, the index data options 130, the client device 140, a non-select bin 205, and a select bin 210.

In the schematic 200, the index data options 130 may be sent to the client device 140 at temporally distinct moments in time (e.g., sent from the server 105, a third party client device, etc.). For example, a first index data 130a may be sent to the client device at time=t1. In these or other embodiments, other index data besides the first index data 130a (e.g., future index data) may or may not yet be generated/determined. Additionally or alternatively, at some time=t₁+T_{const.}, the client device 140 may send the first index data 130a to the non-select bin 205. T_{const.} may represent a constant amount of time where the user has to select the index data (in this case the first index data 130a). T_{const.} may be displayed as an initial duration in a time clock interface element of the user interface element and may constitute a value of about 5 seconds, about 10 seconds, about 30 seconds, about 60 seconds, about 180 seconds, etc. Once the duration in the time clock interface element expires, in this example the first index data 130a is sent to the non-select bin 205. In these or other embodiments, index data may be sent to the non-select bin 205 in response to the user not selecting the index data (e.g., not interfacing a lock interface element to lock-in the index data) before the duration in the time clock interface element expires. The non-select bin 205 may reside within the server 105, such as in the user input manager 135 and/or the index data manager 115.

In some embodiments, the second index data 130b may be sent to the client device 140 at time=t2. In these or other embodiments, other index data besides the second index data 130b (e.g., future index data) may or may not yet be generated/determined. In some embodiments, t2 may be the same time as t₁+T_{const.} In other terms, at time=t2, the first index data 130a may be sent to the non-select bin 205, and simultaneously the second index data 130b may be sent from the index data manager 115 to the client device 140 and/or displayed at the client device 140. In other embodiments, t2 may be temporally distinct from t₁+T_{const.} such that the first index data 130a may be sent to the non-select bin 205 at a different time than the second index data 130b is sent from the index data manager 115 to the client device 140 and/or displayed at the client device 140.

In some embodiments, at time=t₂+T_{const.}, the second index data 130b may be sent to the non-select bin 205 (e.g., the duration of time on the time clock interface that corresponds to the second index data 130b expired). Additionally or alternatively, in some embodiments, at time=tₙ₋₂, an n^{th-2} index data 130c may be sent to the client device 140. In these or other embodiments, other index data besides the n^{th-2} index data 130c (e.g., future index data) may or may not yet be generated/determined. In response to a user input received at the client device 140 within the lifetime of the n^{th-2} index data 130c displayed on the time clock interface, the n^{th-2} index data 130c may be sent to the select bin 210. In other terms, the user input may be acceptable to lock in the n^{th-2} index data 130c if within time=tₙ₋₂+T_{const.}−t (where 0<t>T_{const.}). In these or other embodiments, index data may be sent to the select bin 210 in response to the user selecting the index data (e.g., interfacing a lock interface element to lock-in the index data). The select bin 210 may reside within the server 105, such as in the user input manager 135 and/or the index data manager 115.

Though described in additional detail below in conjunction with FIGS. 4A-4F, once the index data is locked-in (e.g., the n^{th-2} index data 130c is in the select bin 210), the locked-in index data may be updated or replaced with different index data. For example, until the locked-in index data is finalized, different index data may be visible within the user interface and available for selecting. Alternatively, the locked in index data may be finalized (e.g., the item may be purchased at the finalized price).

In these or other embodiments, FIG. 2 may be implemented at the server 105 and/or at the client device 140. For example, the index data manager 115 may reside in one or both of the server 105 and the client device 140. In these or other embodiments, the index data options 130 may be determined one at a time, in multiple sets of index data at a time, or in other suitable ways.

Modifications, additions, or omissions may be made to the schematic 200 without departing from the scope of the present disclosure. For example, in some embodiments, the schematic 200 may include any number of other components that may not be explicitly illustrated or described.

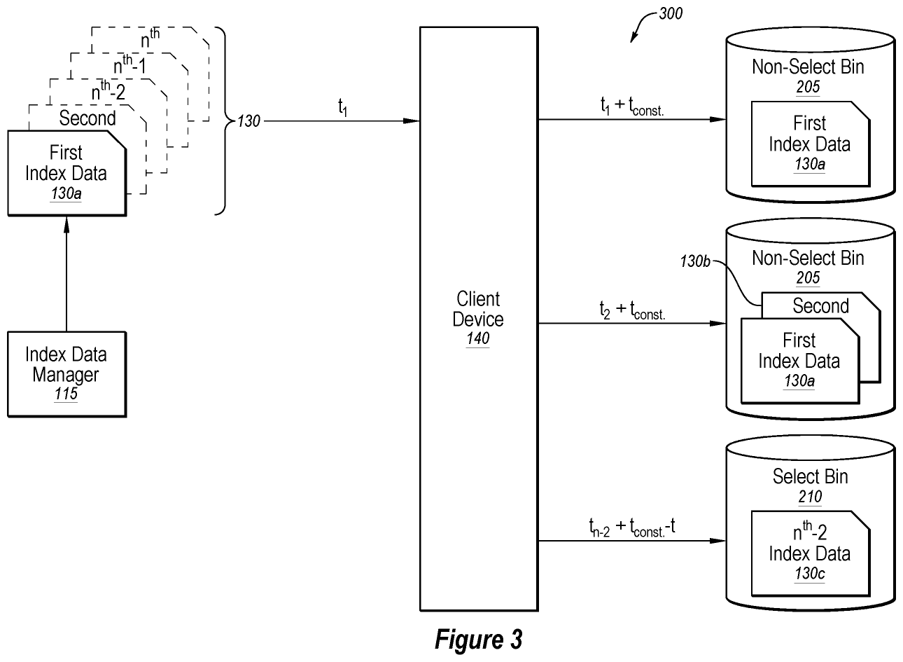

FIG. 3 illustrates another example schematic 300 depicting an example flow of index data relative to the index data manager 115 and the client device 140, arranged in accordance with at least one embodiment described in the present disclosure. As illustrated, the schematic 300 may include the index data manager 115, the index data options 130, the client device 140, the non-select bin 205, and the select bin 210.

Portions of the schematic 300 may be the same as or similar to the schematic 200. In the schematic 300, however, the index data options 130 may be sent to the client device 140 in multiple sets of index data (e.g., all index data or just some index data such as in groups of 2, 3, 5, 10, 50, 100, etc. for one or more items). In these or other embodiments, the client device 140 may perform one or more operations performable by the index data manager 115. For example, the index data options 130 may include computer-executable instructions that, when executed by the client device 140, adjust or generate curves based on user inputs and/or a lack thereof. In this manner, the server 105 may send index data options 130 to the client device 140, and the client device 140 may adjust the index data options 130 and/or generate new index data options 130. Additionally or alternatively, the server 105 may instruct the client device 140 (e.g., the index data manager 115 within the client device 140) to perform some or all generation of the index data options 130 as described above (e.g., multiple sets of index data at a time).

Modifications, additions, or omissions may be made to the schematic 300 without departing from the scope of the present disclosure. For example, in some embodiments, the schematic 300 may include any number of other components that may not be explicitly illustrated or described.

FIGS. 4A-4F illustrate example user interfaces 400a-400f of the client device 140, arranged in accordance with at least one embodiment described in the present disclosure.

In FIG. 4A, the user interface 400a may include the media item information 402, first index data 405a, a time clock 410, a lock interface element 415, a lock status 420, and a color 425. In these or other embodiments, the media item information 402 may include a picture image, a video file, or some other visual representation of an item. Additionally or alternatively, the media item information 402 may include a written description of the item such as a brief overview, a product description, technical details and specifications, reviews, ratings, etc. that may help identify to a user what the item is.

The first index data 405a may, as described above, include a price, an amount of loyalty points, a discount amount, and/or some other value configured to be associated with an item such as a product for sale, or a combination thereof. For example, the first index data 405a may include an indicator of “−20%,” a discount price of “$80,” a crossed out original price of a token price of 350 loyalty points, and/or any other suitable value to be associated with an item. In these or other embodiments, one or more portions of the first index data 405a may correspond to the color 425 described in detail below.

In some embodiments, index data may be adjusted based on an amount of loyalty points. For example, the first index data 405a may display “−20%,” but a threshold amount of loyalty points may, at the option of the user, increase the discount to some other number such as “−25%” or “−40%” or even up to “−100%” (e.g., dollar free, but high in loyalty points). In these or other embodiments, the loyalty points may be one-dimensional or multi-dimensional. For example, the “cost” to lock a given index data may be controlled with a same set of loyalty points that help define the curve associated with the user and or product, while in other embodiments different sets of loyalty points may be used. Additionally or alternatively, the amount of loyalty points required to lock-in a given set of index data may correspond to a particular curve, e.g., a different curve than what corresponds to the index data options 130. The curve corresponding to a lock cost (e.g., the amount of loyalty points required to lock-in a given set of index data) may be generated using the same or similar methodologies as described in conjunction with curve generation in FIG. 5. In these or other embodiments, the lock cost may be related to or in some manner based on changes to the index data options 130.

The time clock 410 may include a graphical representation of time (e.g., a clock, a watch, a timer, an hour glass, a stopwatch, a countdown, a count-up, an alarm, etc.). In these or other embodiments, the time clock 410 may represent a duration of time where index data is available to be selected (e.g., locked-in) by the user via a user input. In the example of the user interface 400a in FIG. 4A, the time clock 410 may include or display a remaining amount of time left in a first duration of time. For example, the time clock 410 may display “5” seconds left from what was originally a larger duration of time (e.g., the entire first duration of time such as “10” seconds or some other suitable duration of time). In this manner, the time clock 410 may display that the first index data 405a is not yet expired, but has, for example, five seconds remaining before expiration. In these or other embodiments, the time clock 410 may correspond to the color 425 described in detail below.

To select (e.g., lock-in) the item at the first index data 405a (in this example, $80), the user may or may not choose to interface with the lock interface element 415. The lock interface element 415 may be a button that, when clicked/pressed/tapped/slid, automatically sends a message or signal from the client device 140 to the server 105 locking in a given index data. Additionally or alternatively, the lock interface element 415 may initiate at the client device 140, a pop-up, a blank message/email, an indication to perform a voice command, an indication to the user to provide a tactile input to the client device 140, etc. In this manner, the lock interface element 415 may serve as a mechanism to communicate from the client device 140 to the server 105 and lock-in a given index data. In some embodiments, the user may cycle through any number of index data before ever choosing to lock-in a given index data.

Additionally or alternatively, the lock interface element 415 may include or be associated with an amount of loyalty points required in order to interface with the lock interface element 415. For example, to interface with the lock interface element 415 (e.g., lock-in a given index data), the user may be required to spend 1, 5, 10, 50, 100, or some other number of loyalty points. In some cases, the lock interface element 415 may be free (no loyalty points required). For example, if the user has not yet locked-in a given index data, if the user is a first-time user, if the user is participating on a “guest” account, and/or in any other potential scenario of incentivizing participation, retention, loyalty, conversion, etc., the user may be given a certain number of free locks. Additionally or alternatively, the lock interface element 415 may require an amount of loyalty points based on the quality/type of index data. For example, a “magical” or “rare” deal as described below may require a higher amount of loyalty points than a “common” or “stock” deal (also described below).

Additionally or alternatively, the lock interface element 415 may require an amount of loyalty points that is inversely related to the quality of a given index data (e.g., how low the price is). For example, in one embodiment, a current deal may include a retail price of $10, index data indicating a sale price of $9, and a lock cost of 5 loyalty points. After a duration of time (e.g., 10 seconds), the index data changes to indicate a drop in sale price to $7. In this example, the different index data indicating a cheaper sale price may cause the lock cost to increase (e.g., to 12 loyalty points).

In another example using the above example deal of a retail price of $10, index data indicating a sale price of $9, and a lock cost of 5 loyalty points, the following example scenario may apply: the user may choose to lock-in the index data corresponding to the $9 sale price. In such a case, the different index data subsequently displayed to the user may indicate a lock cost of only 7 loyalty points as opposed to the example 12 loyalty points for the example scenario above not locking-in the $9 sale price. Thus, in some embodiments, the lock interface element 415 may indicate a lock cost that corresponds to the index data options 130 and/or an associated curve to the index data options 130.

In these or other embodiments, when the user has not selected a given index data (e.g., locked-in via the lock interface element 415), the lock status 420 may indicate that the given index data is not locked-in. For example, the lock status 420 may include a graphical representation such as a padlock, a lock, a combination lock, a key-lock, a deadbolt, or some other representation configured to indicate a locked or unlocked status of the index data. For example, a padlock of the lock status 420 in the locked state may depict a neck connected and locked into a body of the padlock. As another example, if the padlock of the lock status 420 is in the unlocked stated, the neck of the padlock may be depicted as disconnected or open from the body of the padlock. Additionally or alternatively, the lock status 420 may include a simple descriptor or worded identifier such as “LOCKED” or “UNLOCKED” to indicate the locked or unlocked status of the index data. In the example of the user interface 400a in FIG. 4A, the user has not selected any index data, specifically the first index data 405a, and the lock status 420 may therefore indicate a status of unlocked. In these or other embodiments, the lock status 420 may correspond to the color 425 described in detail below.

In some embodiments, the color 425 may correspond to a quality/type of the index data (e.g., a discount amount). For example, one color may correspond to a “magical” deal (e.g., an extremely good discount). Another color may correspond to a “rare” deal (e.g., a very good discount). Another color may correspond to an “uncommon” deal (e.g., a good discount). Another color may correspond to a “common” deal (e.g., a low discount). Another color may correspond to a “stock” deal (e.g., almost no discount). The above-mentioned example color categories are examples, and other color categories may be implemented in a cueing system.

In these or other embodiments, though the cueing system may be optional, the cueing system may help the user more efficiently identify the quality/type of the index data. For example, in an example case where the user interface displays multiple items at once, many of which may have distinct index data, the user may be able to visually watch for a particular color, shape, symbol, icon, etc. (e.g., the “rare” deal) as opposed to searching numbers, scrolling, filtering, sorting, visiting other websites and alternative sources, etc. In another example user interface, the user interface may display dozens or even hundreds of items at once with little or no identifiers (e.g., just color 425 and perhaps media item information 402 in the form of a picture). In such an example user interface, the user may efficiently navigate to desirable or preferred deals among dozens or hundreds of deals at once using the cueing system that corresponds to the index data.

Returning to the user interface 400a, in FIG. 4A, one or more portions of the user interface 400a with respect to an item described in the media item information 402 may correspond to the color “A.” For example, one or more of the first index data 405a, the time clock 410, the lock interface element 415, and the lock status 420 may correspond to the color “A.”

To transition from the user interface 400a to the user interface 400b, one or more portions of the user interface 400a may re-render, refresh, newly generate, withdraw, exit, disappear, phase-in, phase-out, change, move, etc. For example, any color, text, image, pixel, etc. as may be shown in the various elements of the user interface 400a may be altered in part or in whole. In these or other embodiments, one or both of the client device 140 and the server 105 may cause a processor to perform such alterations to the user interface 400a to thereby arrive at the user interface 400b. The user interface 400b in FIG. 4B may include the second index data 405b. In this example, the first duration corresponding to the first index data 405a has expired. Thus, the first index data 405a is no longer available to be selected (e.g., locked-in) by a user input from the user. Rather, as displayed in the user interface 400b of FIG. 4B, the second index data 405b may be available to be selected for the second duration of time as displayed in the time clock 410. Here, as an example, the second index data 405b may correspond to the color “B.”

To transition from the user interface 400b to the user interface 400c, one or more portions of the user interface 400b may re-render, refresh, newly generate, withdraw, exit, disappear, phase-in, phase-out, change, move, etc. For example, any color, text, image, pixel, etc. as may be shown in the various elements of the user interface 400b may be altered in part or in whole. In these or other embodiments, one or both of the client device 140 and the server 105 may cause a processor to perform such alterations to the user interface 400b to thereby arrive at the user interface 400c. In FIG. 4C, the user interface 400c illustrates that the user has, in this example, locked-in the second index data 405b. Though the second duration has expired or been rendered moot (as may be depicted by the time clock 410a), the user may have the option at any time without additional time constraints to finalize (e.g., purchase) the item at the locked-in price corresponding to the second index data 405b. For example, the user may be able to finalize the item via the finalize interface element 430. Similar to the lock interface element 415, the finalize interface element 430 may be a button that, when clicked/pressed/tapped/slid, automatically sends a message or signal from the client device 140 to the server 105 that purchases the item. Additionally or alternatively, the finalize interface element 430 may initiate at the client device 140, a pop-up, a blank message/email, an indication to the user to perform a voice command, an indication to the user to provide a tactile input to the client device 140, etc. In this manner, the finalize interface element 430 may serve as a mechanism to communicate from the client device 140 to the server 105 and purchase an item at the locked-in index data. As also illustrated in FIG. 4C, the second index data 405b may be associated with a lock status 420a as “locked.”

Further illustrated in FIG. 4C is the third index data 405c, e.g., alternative index data to the locked-in index data. In this example, the user has the option to de-select the locked-in index data 405b by affirmatively selecting the third index data 405c via the lock interface element 415. Additionally or alternatively, the user may have the option to affirmatively select the third index data 405c such that the prior locked-in index data is not de-selected. For example, the user may, in some embodiments, have multiple sets of locked-in index data at any given time. However, as the case for any unlocked index data, the third index data 405c may only be selectable within a corresponding duration of time (e.g., the third duration of time) as depicted by the time clock 410b. In some embodiments, the user may continue to cycle through any number of alternative index data before ever finalizing the locked-in item or selecting another alternative index data.

To transition from the user interface 400c to the user interface 400d, one or more portions of the user interface 400c may re-render, refresh, newly generate, withdraw, exit, disappear, phase-in, phase-out, change, move, etc. For example, any color, text, image, pixel, etc. as may be shown in the various elements of the user interface 400c may be altered in part or in whole. In these or other embodiments, one or both of the client device 140 and the server 105 may cause a processor to perform such alterations to the user interface 400c to thereby arrive at the user interface 400d. In FIG. 4D, the user interface 400d illustrates that the user has, in this example, maintained the second index data 405b as “locked.” For example, the third index data 405c may have been the same or similar such that the third index data 405c was not a deal worth locking in to replace the second index data 405b. In other terms, since the third index data 405c corresponded to the same color “B” also associated with the second index data 405b, the user did not choose to lock-in the third index data 405c, and the third index data 405c expired upon expiration of the third duration. Thus, as illustrated by way of example in FIG. 4D, the fourth index data 405d associated with the color “C” is available for selecting during a fourth duration of time depicted in the time clock 410b.

To transition from the user interface 400d to the user interface 400e, one or more portions of the user interface 400d may re-render, refresh, newly generate, withdraw, exit, disappear, phase-in, phase-out, change, move, etc. For example, any color, text, image, pixel, etc. as may be shown in the various elements of the user interface 400d may be altered in part or in whole. In these or other embodiments, one or both of the client device 140 and the server 105 may cause a processor to perform such alterations to the user interface 400d to thereby arrive at the user interface 400e. In FIG. 4E, the user interface 400e illustrates that the user has, in this example, de-selected the previously locked second index data 405b by affirmatively selecting the fourth index data 405d (albeit in some embodiments, multiple index data may be locked at the same time). Though the fourth duration has expired or been rendered moot (as may be depicted by the time clock 410a), the user may have the option at any time without additional time constraints to finalize (e.g., purchase) the item at the locked-in price corresponding to the fourth index data 405d. For example, the user may be able to finalize the item via the finalize interface element 430.

Further illustrated in FIG. 4E is the fifth index data 405e, e.g., alternative index data to the locked-in index data. In this example, the user has the option to de-select the locked-in index data 405d by affirmatively selecting the third index data 405e via the lock interface element 415. Additionally or alternatively, the user may have the option to affirmatively select the fifth index data 405e such that the prior locked-in index data is not de-selected. For example, the user may, in some embodiments, have multiple sets of locked-in index data at any given time. However, as the case for any unlocked index data, the fifth index data 405e may only be selectable within a fifth duration of time as depicted by the time clock 410b.

To transition from the user interface 400e to the user interface 400f, one or more portions of the user interface 400e may re-render, refresh, newly generate, withdraw, exit, disappear, phase-in, phase-out, change, move, etc. For example, any color, text, image, pixel, etc. as may be shown in the various elements of the user interface 400e may be altered in part or in whole. In these or other embodiments, one or both of the client device 140 and the server 105 may cause a processor to perform such alterations to the user interface 400e to thereby arrive at the user interface 400f. In FIG. 4F, the user interface 400f illustrates that the user, in this example, has interfaced with the finalize interface element 430 to purchase the item at the fourth index data 405d. Thus, in some embodiments, the user interface 400f may display the confirmation element 435 to confirm the purchase, constituting an example manual process. For instance, the confirmation element 435 may initiate a confirmation page for the user to confirm shipping methods, payment methods, address, etc. In other embodiments, the purchase may be automatic upon interfacing with the finalize interface element 430. In these or other embodiments, the fourth index data 405d corresponding to the color “C” may have been a better deal than the fifth index data 405e corresponding to the color “A” and/or a better deal than the first index data 405a also corresponding to the color “A” and/or a better deal than the second index data 405b and the third index data 405c corresponding to the color “B.” In some embodiments, a better deal may correspond to a larger discount from, for example, the retail price. However, in these or other embodiments, a better deal may not be guaranteed as each index data among the index data options 130 may be more or less advantageous from the perspective of the user, and each index data of the index data options 130 may be the same, higher, or lower in price than the previous or next index data.

Modifications, additions, or omissions may be made to the user interfaces 400a-400f without departing from the scope of the present disclosure. For example, in some embodiments, the user interfaces 400a-400f may include any number of other components that may not be explicitly illustrated or described.

FIG. 5 illustrates an example curve fit schematic 500 generated by the curve fit manager 120, arranged according to at least one embodiment of the present disclosure. As illustrated, the curve fit schematic 500 may include curves 505-525, output 530, and input 535. In these or other embodiments, the curve fit manager 120 may generate more or less curves than are illustrated in the curve fit schematic 500.

In some embodiments, a curve such as any of the curves 505-525 may be generated using some formula-defined curve or polynomial curve. The curves generated by the curve fit manager 120 may adjust/generate the curves to a desirable setting, e.g., such that the curve shift, curvature, distribution, etc. is adjusted to create a desirable outcome such as pricing. The curve fit manager 120 may select points along the adjusted curve using a pseudo-random number generator (PRNG) to produce an even distribution or near even distribution that approximates the properties of random values from the custom curve. Additionally or alternatively, the curve fit manager 120 may select points from the adjusted curve using a hash function or some other custom function that is configured to receive an input such as an index data mapping number (corresponding to a particular index data) and based on that calculate some floating point number between 0 and 1. The floating point number between 0 and 1 as randomly generated or approximately-randomly generated may be included in the input 535. Based on the randomly generated or approximately-randomly generated input value (e.g., input 535) in the range [0, 1], the output 530 may be some value (e.g., the index data or a value related to the index data) along the adjusted curve.

In some embodiments, the output 530 may be achieved by the curve fit manager 120 transforming the input 535 using one or more formulas. For example, the curve fit manager 120 may perform the transformation by calculating the output 530 as the y-coordinate of a Bernstein polynomial with one or more control points, or in the case of the Bernstein polynomial-Bernstein coefficients, (e.g., 2, 3, 5, 7, 10, 15, or some other suitable number of control points) with output values (e.g., y-values in the range of [0, 1]). In other embodiments, other types of formula-based transformation curves may be used as the Bernstein polynomial is but one example.

In these or other embodiments, the output 530 may correspond to price, margin (e.g., revenue), sale price, discount percentage, or any other desired metric related to the index data options 130. For example, price may be represented as follows: Price=min+m*(retail-min) where retail may represent the retail price, e.g., MSRP or an actual retail price of one or more sellers, and min may represent a minimum price such as a wholesale price, a “break-even” price (e.g., at cost price), or some other price threshold. The variable m may represent a given output 530 data point in the range [0, 1]. In these or other embodiments, when m=0, the price corresponding to a given index data is the minimum price as discussed above. When m=1, the price corresponding to a given index data is the retail price as discussed above. Additionally or alternatively, the output 530 may correspond to one or more index data mapping values, a list of points to tune the transformation curve (e.g., one of the curves 505-525), and/or a duration of time for which each given index data is available for selecting.

In some embodiments, the curves 505-525 may be the same or different curves. As illustrated, the curve 505 may be a particular curve based on the user behavior parameter 110a following a Type A kind of user behavior. In some embodiments, the curve 510 may be a particular curve based on the user behavior parameter 110a following a Type B kind of user behavior. In some embodiments, the curve 515 may be a particular curve based on the user behavior parameter 110a following a Type C kind of user behavior. In some embodiments, the curve 520 may be a particular curve based on a particular kind of product. In some embodiments, the curve 525 may be a particular curve based on a particular category of products. Thus, in some embodiments, according to the example curve fit schematic 500, a user would be more likely to interface with higher index data (e.g., higher prices where the output 530 corresponds to price) when participating with a Type C kind of user behavior parameter 110a (associated with curve 515) than if the user were participating with a Type A kind of user behavior parameter 110a (associated with curve 505). Thus, in some embodiments, multiple users may simultaneously view a product, but each of the multiple users may view different index data associated with the product at any one time due to, for example, associating with different curves or associating to different portions of the same curve, etc.

Modifications, additions, or omissions may be made to the curve fit schematic 500 without departing from the scope of the present disclosure. For example, in some embodiments, the curve fit schematic 500 may include any number of other components that may not be explicitly illustrated or described.

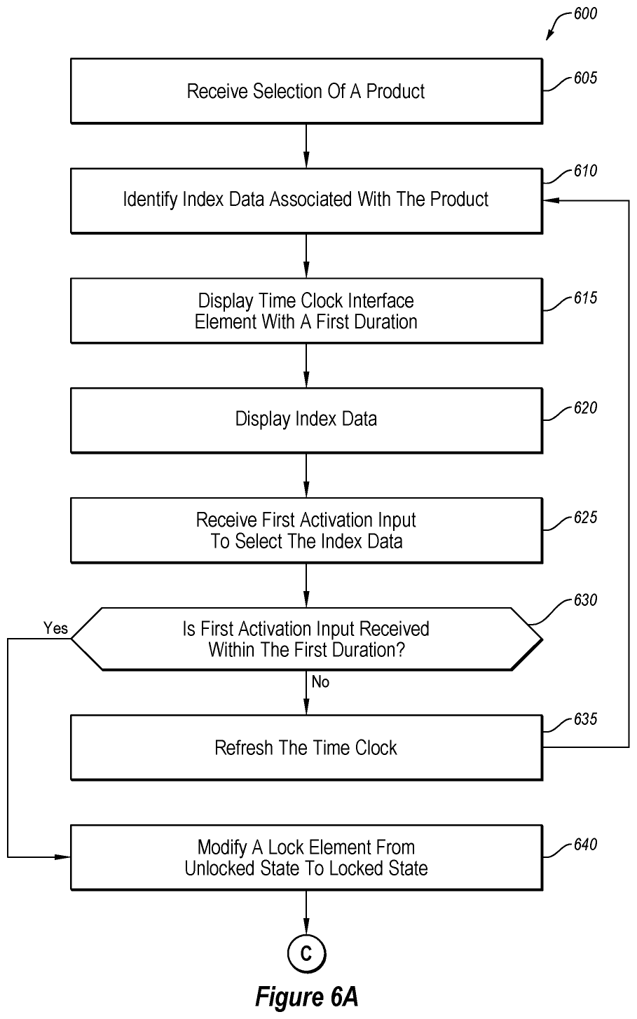

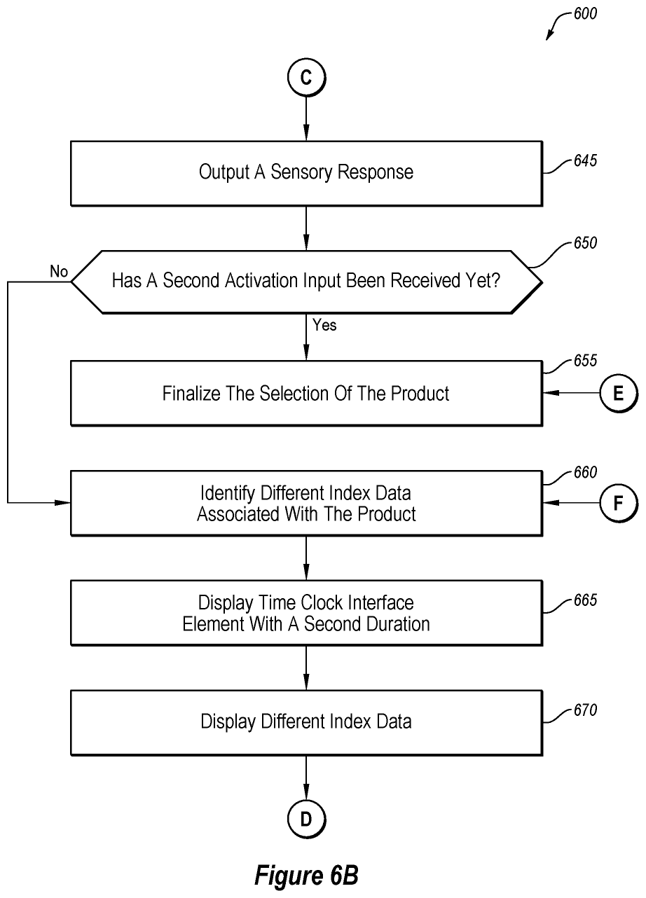

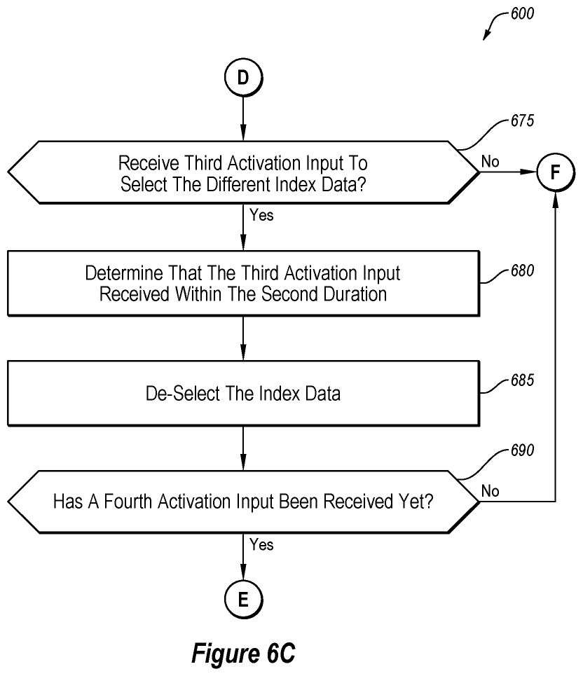

FIGS. 6A-6C illustrate an example method 600 to facilitate locking-in and finalizing index data. The method 600 may be performed by processing logic that may include hardware (circuitry, dedicated logic, etc.), software (such as is run on a general purpose computer system or a dedicated machine), or a combination of both, which processing logic may be included in the client device 140 of FIG. 1, or another computer system or device. However, another system, or combination of systems, may be used to perform the method 600. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 600 may begin at block 605, where the processing logic may receive a selection of a product via the user interface. The selection may be in the form of a user input effective to select the product (e.g., from a list of products).

At block 610, the processing logic may identify index data associated with the product. For example, the processing logic may identify a number value assigned or mapped to the index data. Using the mapped value, the processing logic may be able to locate the index data and do so within a proper order and time manner.

At block 615, the processing logic may cause the user interface to display a time clock interface element with a first duration. In these or other embodiments, the index data associated with the product may be selectable within the first duration of time that is displayed on the time clock interface element.

At block 620, the processing logic may cause the user interface to display index data. The index data may be associated with the product and a first user interface element that, when executed, selects as reserved one or both of the product and the index data associated with the product. Examples of the first user interface element may include the lock interface element as described in conjunction with FIGS. 4A-4F.

At block 625, the processing logic may receive a first activation input via the user interface effective to select the index data. Examples of the first activation input may include a user input such as a swipe gesture, a tap, a click, a voice command, a tactile input (e.g., a shake of a client device), etc. The first activation input may include any interfacing with the lock interface element (e.g., a first interface element) as described in conjunction with FIGS. 4A-4F.

At block 630, the processing logic may determine that the first activation input is received within the first duration of time displayed on the time clock interface element. For example, the processing logic may determine that the first activation input was received at the user interface within the first duration by verifying a relay signal is transmitted from, e.g., the lock interface element (or the first user interface element) within the first duration of time. Additionally or alternatively, the processing logic may determine that the first activation input was received at the user interface within the first duration by verifying the relay signal is transmitted to the processing logic within a tolerance period of time after the first duration of time. The tolerance period of time may help to ensure that last-second first activation inputs are received at the processing logic as timely.

If the first activation input is not received within the first duration, then the method 600 may proceed to block 635 where the processing logic may refresh at least a portion of the user interface, including the time clock interface element, and then proceed back to block 610 where the processing logic identifies another index data associated with the product.

If the first activation input is received within the first duration, then the method 600 may proceed to block 640 where the processing logic may modify at least a portion of the user interface, including a lock element from an unlocked state to a locked state. The method 600 may then proceed to block 645 where the processing logic may cause one or both of the user interface and the client device to output a sensory response. The sensory response may include one or more of a visual response, an auditory response, a tactile response, etc. A sensory response may include for example, a vibration, a buzz, a beep, a visual light flash, an alarm, a displayed graphic, etc. The processing logic may cause a first sensory response at the user interface to sync with a second sensory response at another component of the client device (e.g., a speaker or flashlight).

At block 650, the processing logic may determine if the second activation input has been received. For example, the processing logic may determine that the second activation input was received at the user interface by confirming a relay signal is transmitted from, e.g., the finalize interface element as described in conjunction with FIGS. 4A-4F.

If the processing logic does determine that the second activation input has been received, then the method 600 may proceed to block 655 where the selection of the product may be finalized (e.g., purchased). The finalizing of the product via, e.g., the finalize interface element, may be an automatic process such as a 1-click purchase or it may be a manual process involving further steps such as payment entry, shipping method entry, etc. If block 655 is reached, the method 600 may end.

If the processing logic does not determine that the second activation input has been received, then the method 600 may proceed to block 660. At block 660, the processing logic may identify different index data associated with the product. For example, the processing logic may identify a number value assigned or mapped to the different index data. Using the mapped number value, the processing logic may be able to locate the different index data and do so within a proper order and time manner.

At block 665, the processing logic may cause the user interface to display a time clock interface element with a second duration. In these or other embodiments, the different index data associated with the product may be selectable within the second duration of time that is displayed on the time clock interface element.

At block 670, the processing logic may cause the user interface to display different index data. The different index data may be associated with the product and a second user interface element that, when executed, selects as reserved one or both of the product and the different index data associated with the product. Examples of the second user interface element may include the lock interface element as described in conjunction with FIGS. 4A-4F.

At block 675, the processing logic may receive a third activation input via the user interface effective to select the different index data. Examples of the third activation input may include a user input such as a swipe gesture, a tap, a click, a voice command, a tactile input (e.g., a shake of the client device), etc. The third activation input may include any interfacing with the lock interface element (e.g., a second user interface element) as described in conjunction with FIGS. 4A-4F. If the processing logic does not receive a third activation input via the user interface, the method 600 may proceed back to block 660 where another different index data to be associated with the product is identified. Otherwise, the method 600 may proceed to block 680.

At block 680, the processing logic may determine that the third activation input is received within the second duration of time displayed on the time clock interface element. For example, the processing logic may determine that the third activation input was received at the user interface within the second duration by verifying a relay signal is transmitted from, e.g., the lock interface element (or the second user interface element) within the second duration of time. Additionally or alternatively, the processing logic may determine that the third activation input was received at the user interface within the second duration by verifying the relay signal is transmitted to a computing element or processor within the processing logic within a tolerance period of time after the second duration of time. The tolerance period of time may help to ensure that last-second third activation inputs are received at the processing logic as timely.

At block 685, the index data may be de-selected by affirmatively selecting the different index data. For example, the index data previously locked-in may be updated or replaced by locking in the different index data. Additionally or alternatively, the user may have the option to affirmatively select the index data such that a prior locked-in index data is not de-selected. For example, the user may, in some embodiments, have multiple sets of locked-in index data at any given time.

At block 690, the processing logic may determine if a fourth activation input has been received. For example, the processing logic may determine that the fourth activation input was received at the user interface by confirming a relay signal is transmitted from, e.g., the finalize interface element as described in conjunction with FIGS. 4A-4F.

If the processing logic does determine that the fourth activation input has been received, then the method 600 may proceed to block 655 where the selection of the product may be finalized (e.g., purchased). The finalizing of the product via, e.g., the finalize interface element, may be an automatic process such as a 1-click purchase or it may be a manual process involving further steps such as payment entry, shipping method entry, etc. If block 655 is reached, the method 600 may end. Otherwise, if the processing logic does not determine that the second activation input has been received, then the method 600 may proceed to block 660 and repeat steps thereafter as necessary until the process ends at block 655.

One skilled in the art will appreciate that, for these processes, operations, and methods, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

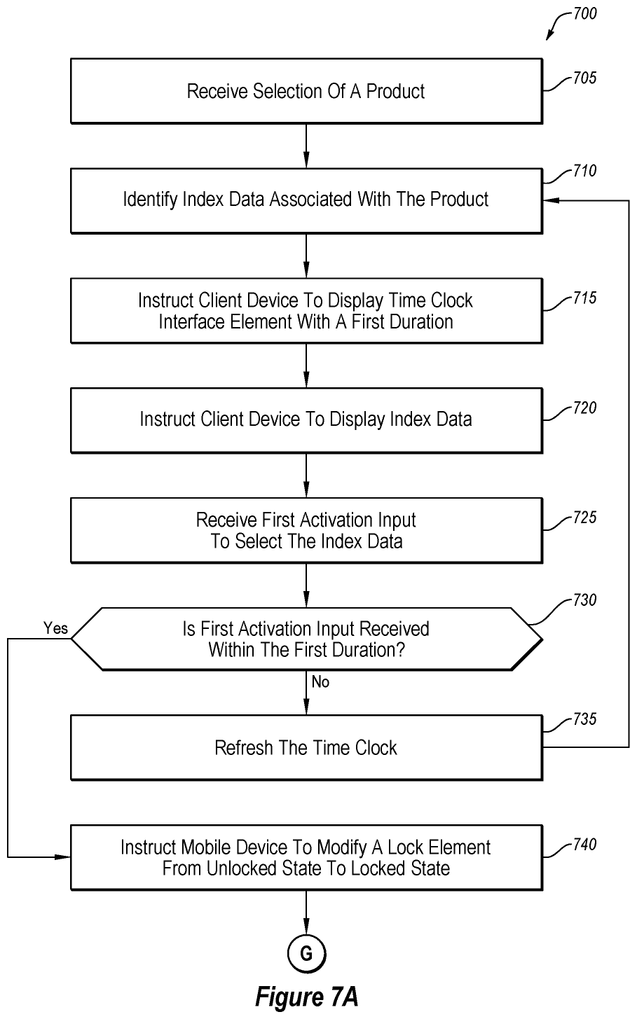

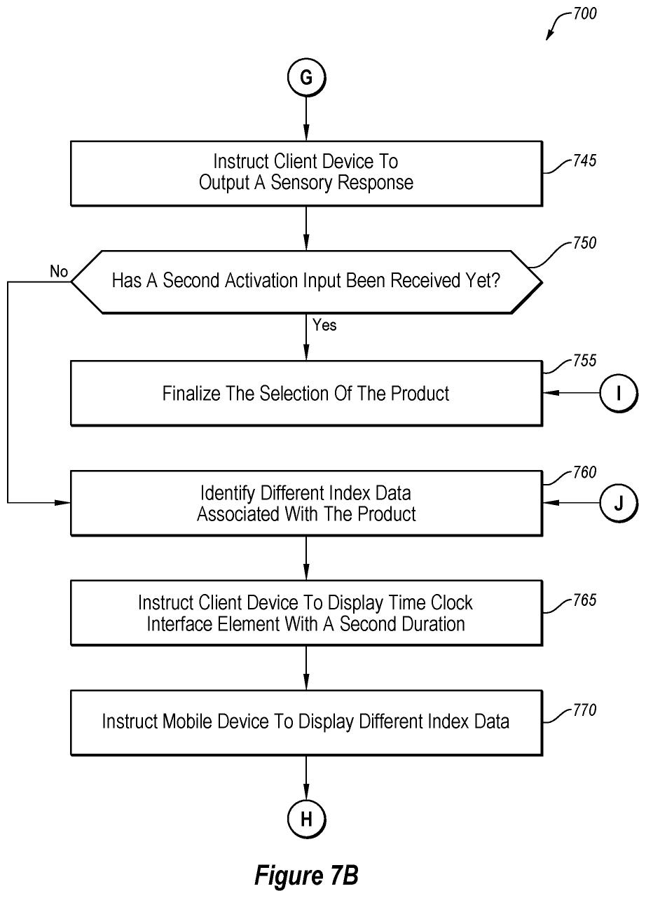

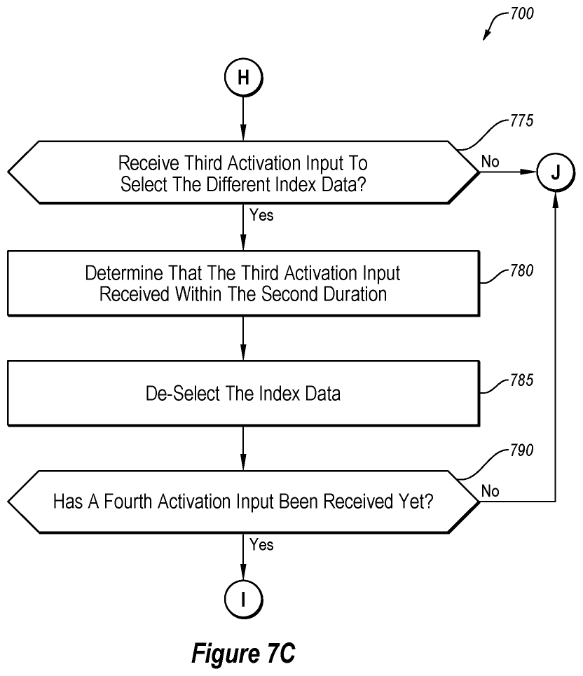

FIGS. 7A-7C illustrate an example method 700 to facilitate locking-in and finalizing index data. The method 700 may be performed by processing logic that may include hardware (circuitry, dedicated logic, etc.), software (such as is run on a general purpose computer system or a dedicated machine), or a combination of both, which processing logic may be included in the server 105 of FIG. 1, or another computer system or device. However, another system, or combination of systems, may be used to perform the method 700. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 700 may begin at block 705, where the processing logic may receive a selection of a product from the client device via the user interface. The selection may be in the form of a user input effective to select the product (e.g., from a list of products).

At block 710, the processing logic may associate index data with the product. For example, the processing logic may assign or map a number value to the index data. Using the mapped number value, the client device may be able to locate the index data and do so within a proper order and time manner.

At block 715, the processing logic may instruct the user interface at the client device to display a time clock interface element with a first duration. In these or other embodiments, the index data associated with the product may be selectable within the first duration of time that is displayed on the time clock interface element.

At block 720, the processing logic may instruct the user interface at the client device to display index data. The index data may be associated with the product and a first user interface element that, when executed, selects as reserved one or both of the product and the index data associated with the product. Examples of the first user interface element may include the lock interface element as described in conjunction with FIGS. 4A-4F.

At block 725, the processing logic may receive a first activation input via the user interface effective to select the index data. Examples of the first activation input may include a user input such as a swipe gesture, a tap, a click, a voice command, a tactile input (e.g., a shake of the client device), etc. The first activation input may include any interfacing with the lock interface element (e.g., a first interface element) as described in conjunction with FIGS. 4A-4F.

At block 730, the processing logic may determine that the first activation input is received within the first duration of time displayed on the time clock interface element. For example, the processing logic may determine that the first activation input was received at the user interface within the first duration by verifying a relay signal is transmitted from, e.g., the lock interface element (or the first user interface element) within the first duration of time. Additionally or alternatively, the processing logic may determine that the first activation input was received at the user interface within the first duration by verifying the relay signal is transmitted to the processing logic within a tolerance period of time after the first duration of time. The tolerance period of time may help to ensure that last-second first activation inputs are received at the processing logic as timely.

If the first activation input is not received within the first duration, then the method 700 may proceed to block 735 where the processing logic may refresh at least a portion of the user interface, including the time clock interface element, and then proceed back to block 710 where the processing logic identifies another index data associated with the product.

If the first activation input is received within the first duration, then the method 700 may proceed to block 740 where the processing logic may instruct the client device to modify at least a portion of the user interface, including a lock element from an unlocked state to a locked state. The method 700 may then proceed to block 745 where the processing logic may instruct one or both of the user interface and the client device to output a sensory response. The sensory response may include one or more of a visual response, an auditory response, a tactile response, etc. A sensory response may include for example, a vibration, a buzz, a beep, a visual light flash, an alarm, a displayed graphic, etc. The processing logic may instruct a first sensory response at the user interface to sync with a second sensory response at another component of the client device (e.g., a speaker or flashlight).

At block 750, the processing logic may determine if the second activation input has been received. For example, the processing logic may determine that the second activation input was received at the user interface by confirming a relay signal is transmitted from, e.g., the finalize interface element as described in conjunction with FIGS. 4A-4F.

If the processing logic does determine that the second activation input has been received, then the method 700 may proceed to block 755 where the selection of the product may be finalized (e.g., purchased). The finalizing of the product via, e.g., the finalize interface element, may be an automatic process such as a 1-click purchase or it may be a manual process involving further steps such as payment entry, shipping method entry, etc. If block 755 is reached, the method 700 may end.

If the processing logic does not determine that the second activation input has been received, then the method 700 may proceed to block 760. At block 760, the processing logic may associate different index data with the product. For example, the processing logic may assign or map a number value to the index data. Using the mapped number value, the client device may be able to locate the index data and do so within a proper order and time manner.

At block 765, the processing logic may instruct the user interface at the client device to display a time clock interface element with a second duration. In these or other embodiments, the different index data associated with the product may be selectable within the second duration of time that is displayed on the time clock interface element.

At block 770, the processing logic may instruct the user interface at the client device to display different index data. The different index data may be associated with the product and a second user interface element that, when executed, selects as reserved one or both of the product and the different index data associated with the product. Examples of the second user interface element may include the lock interface element as described in conjunction with FIGS. 4A-4F.

At block 775, the processing logic may receive a third activation input via the user interface effective to select the different index data. Examples of the third activation input may include a user input such as a swipe gesture, a tap, a click, a voice command, a tactile input (e.g., a shake of the client device), etc. The third activation input may include any interfacing with the lock interface element (e.g., a second user interface element) as described in conjunction with FIGS. 4A-4F. If the processing logic does not receive a third activation input via the user interface, the method 700 may proceed back to block 760 where another different index data to be associated with the product is identified. Otherwise, the method 700 may proceed to block 780.

At block 780, the processing logic may determine that the third activation input is received within the second duration of time displayed on the time clock interface element. For example, the processing logic may determine that the third activation input was received at the user interface within the second duration by verifying a relay signal is transmitted from, e.g., the lock interface element (or the second user interface element) within the second duration of time. Additionally or alternatively, the processing logic may determine that the third activation input was received at the user interface within the second duration by verifying the relay signal is transmitted to the processing logic within a tolerance period of time after the second duration of time. The tolerance period of time may help to ensure that last-second third activation inputs are received at the processing logic as timely.

At block 785, the index data may be de-selected by affirmatively selecting the different index data. For example, the index data previously locked-in may be updated or replaced by locking in the different index data. Additionally or alternatively, the user may have the option to affirmatively select the different index data such that the previously locked-in index data is not de-selected. For example, the user may, in some embodiments, have multiple sets of locked-in index data at any given time.

At block 790, the processing logic may determine if a fourth activation input has been received. For example, the processing logic may determine that the fourth activation input was received at the user interface by confirming a relay signal is transmitted from, e.g., the finalize interface element as described in conjunction with FIGS. 4A-4F.

If the processing logic does determine that the fourth activation input has been received, then the method 700 may proceed to block 755 where the selection of the product may be finalized (e.g., purchased). The finalizing of the product via, e.g., the finalize interface element, may be an automatic process such as a 1-click purchase or it may be a manual process involving further steps such as payment entry, shipping method entry, etc. If block 755 is reached, the method 700 may end. Otherwise, if the processing logic does not determine that the second activation input has been received, then the method 700 may proceed to block 760 and repeat steps thereafter as necessary until the process ends at block 755.

One skilled in the art will appreciate that, for these processes, operations, and methods, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

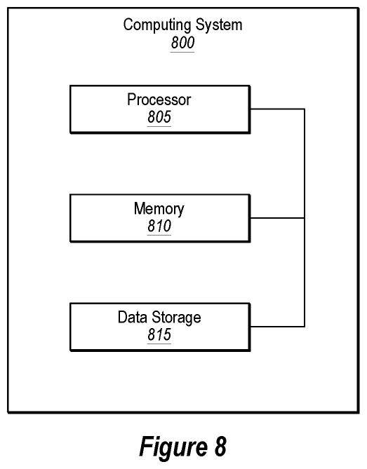

FIG. 8 illustrates a block diagram of an example computing system 800. The computing system 800 may be configured according to at least one embodiment of the present disclosure and may be configured to perform one or more operations related to index data and an improved user interface as described herein. The computing system 800 may include a processor 805, a memory 810, and a data storage 815. The processor 805, the memory 810, and the data storage 815 may be communicatively coupled.

In general, the processor 805 may include any computer, computing entity, or processing device including various computer hardware or software modules and may be configured to execute instructions stored on any applicable computer-readable storage media. For example, the processor 805 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 8, the processor 805 may include any number of processors configured to, individually or collectively, perform or direct performance of any number of operations described in the present disclosure. Additionally, one or more of the processors may be present on one or more different electronic devices, such as different servers.

In some embodiments, the processor 805 may be configured to interpret and/or execute program instructions and/or process data stored in the memory 810, the data storage 815, or the memory 810 and the data storage 815. In some embodiments, the processor 805 may fetch program instructions from the data storage 815 and load the program instructions in the memory 810. After the program instructions are loaded into memory 810, the processor 805 may execute the program instructions.

For example, in some embodiments, the index data options 130 of FIG. 1 may be included in the data storage 815 as program instructions. The processor 805 may fetch the corresponding program instructions from the data storage 815 and may load the program instructions in the memory 810. After the program instructions of the index data options 130 are loaded into memory 810, the processor 805 may execute the program instructions such that the computing system 800 may perform or direct the performance of the operations associated with the index data options 130 as directed by the instructions.

The memory 810 and the data storage 815 may include computer-readable storage media for carrying or having computer-executable instructions or data structures stored thereon. Such computer-readable storage media may include any available media that may be accessed by a computer, such as the processor 805. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

Modifications, additions, or omissions may be made to the computing system 800 without departing from the scope of the present disclosure. For example, in some embodiments, the computing system 800 may include any number of other components that may not be explicitly illustrated or described.

As indicated above, the embodiments described herein may include the use of a special purpose or general purpose computer (e.g., a processor element) including various computer hardware or software modules, as discussed in greater detail below. Further, as indicated above, embodiments described herein may be implemented using computer-readable media (e.g., a memory element) for carrying or having computer-executable instructions or data structures stored thereon.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
receiving, via a user interface of a client device, a selection of a product;
identifying index data associated with the product;
displaying, via the user interface, a time clock interface element, wherein the index data associated with the product is selectable within a first duration of time that is displayed on the time clock interface element;
displaying, via the user interface, the index data associated with the product and a first user interface element that, when executed, selects as reserved the index data associated with the product;
receiving, via the user interface, a first activation input to activate the first user interface element to select as reserved the index data associated with the product;
determining that the first activation input is received within the first duration of time displayed on the time clock interface element;
in response to receiving the first activation input within the first duration:
modifying a lock element of the user interface from an unlocked state to a locked state that indicates the index data associated with the product is reserved; and
outputting, via one or both of the user interface and the client device, a sensory response indicative of the locked state;
determining that a second activation input to finalize the selection of the product and the index data has not yet been received at the client device; and
in response to determining the second activation input has not yet been received at the client device:
identifying different index data associated with the product;
displaying, via the user interface, a second duration of time in the time clock interface element, wherein the different index data associated with the product is selectable within the second duration of time; and
displaying, via the user interface, the different index data associated with the product and a second user interface element that, when executed, selects as reserved the different index data associated with the product.

2. The method of claim 1, further comprising:
receiving, via the user interface, a third activation input to execute the second user interface element to select as reserved the different index data associated with the product;
determining that the third activation input is received within the second duration of time displayed on the time clock interface element; and
one of:
de-selecting the index data such that the index data is unreserved and unavailable for re-selecting; or
preserving the index data such that both of the index data and the different index data are reserved.

3. The method of claim 2, further comprising, after receiving the third activation input within the second duration, receiving a fourth activation input to finalize the selection of the product and the different index data.

4. The method of claim 1, wherein determining that the first activation input is received within the first duration of time includes buffering a refresh of the time clock interface element such that the first activation input is acceptable if received within a sum of the first duration of time and a tolerance period of time.

5. The method of claim 1, wherein the different index data is a first different index data, and the method further comprises:
determining the second activation input has not been received at the client device within the second duration of time;
identifying a second different index data associated with the product;
displaying, via the user interface, a third duration of time in the time clock interface element, wherein the second different index data associated with the product is selectable within the third duration of time; and
displaying, via the user interface, the second different index data associated with the product and a third user interface element that, when executed, selects as reserved the second different index data associated with the product.

6. The method of claim 1, wherein the different index data is adjustable to a different portion of a curve corresponding to the index data or to a new curve according to one or more of: a number of online participants viewing the product, a number of online participants that have selected the product with an associated index data, a conversion rate of a user, a participation duration of the user, and an idle time of the user.

7. The method of claim 6, wherein the curve represents a Bernstein polynomial having at least 4 coefficients.

8. A system comprising:
a memory; and
one or more processors communicatively coupled to the memory, the one or more processors being configured to execute instructions stored in the memory to cause the system to perform operations comprising:
receive, from a client device, a selection of a product;
associate index data with the product;
display, at a user interface of the client device, a time clock interface element, wherein the index data associated with the product is selectable within a first duration of time that is displayed on the time clock interface element;
display, at the user interface, the index data associated with the product and a first user interface element that, when executed, selects as reserved the index data associated with the product;
receive, from the client device, a first activation input to activate the first user interface element to select as reserved the index data associated with the product;
determine that the first activation input is received at the client device within the first duration of time displayed on the time clock interface element;
in response to determining the first activation input is received at the client device within the first duration:
modify a lock element of the user interface from an unlocked state to a locked state that indicates the index data associated with the product is reserved; and
instruct, one or both of the user interface and the client device, to output a sensory response indicative of the locked state;
determine that a second activation input to finalize the selection of the product and the index data has not yet been received at the client device; and
in response to determining the second activation input has not yet been received at the client device:
associate different index data with the product;
display, at the user interface, a second duration of time in the time clock interface element, wherein the different index data associated with the product is selectable within the second duration of time; and
display, at the user interface, the different index data associated with the product and a second user interface element that, when executed, selects as reserved the different index data associated with the product.

9. The system of claim 8, wherein execution of the instructions further causes the system to:
receive, from the client device, a third activation input to execute the second user interface element to select as reserved the different index data associated with the product;
determine that the third activation input is received at the client device within the second duration of time displayed on the time clock interface element; and
one of:
de-select the index data such that the index data is unreserved and unavailable for re-selecting; or
preserve the index data such that both of the index data and the different index data are reserved.

10. The system of claim 9, wherein execution of the instructions further causes the system to, after receiving at the client device the third activation input within the second duration, receive a fourth activation input to finalize the selection of the product and the different index data.

11. The system of claim 8, wherein determining that the first activation input is received within the first duration of time includes buffering, at the server, a refresh of the time clock interface element such that the first activation input is acceptable if received at the server within a sum of the first duration of time and a tolerance period of time.

12. The system of claim 8, wherein the different index data is a first different index data, and execution of the instructions further causes the system to:
determine the second activation input has not been received at the client device within the second duration of time;
associate a second different index data with the product;
display, at the client device, a third duration of time in the time clock interface element, wherein the second different index data associated with the product is selectable within the third duration of time; and
display, at the client device, the second different index data associated with the product and a third user interface element that, when executed, selects as reserved the second different index data associated with the product.

13. The system of claim 8, wherein the different index data is adjustable to a different portion of a curve corresponding to the index data or to a new curve according to one or more of: a number of online participants viewing the product, a number of online participants that have selected the product with an associated index data, a conversion rate of a user, a participation duration of the user, and an idle time of the user.

14. The system of claim 8, wherein execution of the instructions further causes the system to:
generate a curve;
map the index data, wherein the index data corresponds to a data point on the curve; and
select, using a random number generator or a hash function that outputs an even or approximately even distribution of data points, the index data.

15. The system of claim 14, wherein the curve represents a Bernstein polynomial having at least 4 coefficients.

16. A system, comprising:
one or more processors;
non-transitory computer readable media that include instructions thereon that, in response to execution by the one or more processors, control performance of operations comprising:
receive, via a user interface of a client device, a selection of a product;
identify index data associated with the product;
display, via the user interface, a time clock interface element, wherein the index data associated with the product is selectable within a first duration of time that is displayed on the time clock interface element;
display, via the user interface, the index data associated with the product and a first user interface element that, when executed, selects as reserved the index data associated with the product;
receive, via the user interface, a first activation input to activate the first user interface element to select as reserved the index data associated with the product;
determine that the first activation input is received within the first duration of time displayed on the time clock interface element; and
in response to receiving the first activation input within the first duration:
modify a lock element of the user interface from an unlocked state to a locked state that indicates the index data associated with the product is reserved; and
output, via one or both of the user interface and the client device, a sensory response indicative of the locked state.

17. The system of claim 16, wherein the operations further comprise:
determine that a second activation input to finalize the selection of the product and the index data has not yet been received at the client device; and
in response to determining the second activation input has not yet been received at the client device:
identify different index data associated with the product;
display, via the user interface, a second duration of time in the time clock interface element, wherein the different index data associated with the product is selectable within the second duration of time; and
display, via the user interface, the different index data associated with the product and a second user interface element that, when executed, selects as reserved the different index data associated with the product.

18. The system of claim 17, wherein the operations further comprise:
receive, via the user interface, a third activation input to execute the second user interface element to select as reserved the different index data associated with the product;
determine that the third activation input is received within the second duration of time displayed on the time clock interface element; and
one of:
de-select the index data such that the index data is unreserved and unavailable for re-selecting; or
preserve the index data such that both of the index data and the different index data are reserved.

19. The system of claim 18, wherein the operations further comprise:
after receiving the third activation input within the second duration, receive a fourth activation input to finalize the selection of the product and the different index data.

20. The system of claim 17, wherein the operations further comprise:
determine the second activation input has not been received at the client device within the second duration of time;
identify a second different index data associated with the product;
display, via the user interface, a third duration of time in the time clock interface element, wherein the second different index data associated with the product is selectable within the third duration of time; and
display, via the user interface, the second different index data associated with the product and a third user interface element that, when executed, selects as reserved the second different index data associated with the product.
